(19) United States
(12) Patent Application Publication
(10) Pub. No.: US 2005/0078624 A1
(43) Pub. Date: Apr. 14, 2005

(54) Method and apparatus for automatic configuration of wireless networks

(76) Inventors: Zhengjin Shu, San Jose, CA (US); Long Wang, San Jose, CA (US); Frank Huang, Pleasanton, CA (US); Chichian Yu, San Ramon, CA (US); Biju Nair, Buffalo Grove, IL (US)

Correspondence Address: PILLSBURY WINTHROP LLP, 2475 Hanover Street, Palo Alto, CA, 94304-1115, US

(21) Appl. No.: 10/897,876

(22) Filed: Jul. 22, 2004

Related U.S. Application Data
(60) Provisional application No. 60/489,399, filed on Jul. 22, 2003.
(60) Provisional application No. 60/489,408, filed on Jul. 22, 2003.

(51) Int. Cl. H04Q 7/24

(52) U.S. Cl. 370/328

(57) ABSTRACT

A wireless network software access point (AP) integrated into a wireless device allows a wireless network to be configured automatically and dynamically maintained with minimal user intervention. Such automatic configuration includes: whether to configure the Soft AP enabled device to be an AP Node or a Station Node; specifics of wireless radio link configuration, routing or bridging relationships with other networking devices attached to the host-computing device; and firewall configuration. Such automatic configurations are based on the automatic detection of the network environment attached to the Soft AP enabled device. The automatic configurations may also be based on the intelligent interactions among different Soft AP enabled devices in the wireless network, which often includes devices with and without Soft AP functionalities.

### RELATED APPLICATIONS

This application claims the benefit of and incorporates by reference U.S. provisional patent applications 60/489,399, filed Jul. 22, 2003, and entitled Method and Apparatus for Automatic Configuration of Wireless Networks, and 60/489,408, also filed Jul. 22, 2003, entitled System and Method for Wake on Wireless LAN, and further is related to commonly owned and concurrently filed U.S. patent application Ser. No. ______, entitled “System and Method for Wake on Wireless LAN”, attorney docket number 069509-0309910 (client reference PCTEL-13100), which is incorporated herein by reference in its entirety.

### BACKGROUND OF THE INVENTION

1. Field of the Invention

The present invention generally relates to relatively local distance wireless networks, such as a wireless local area network (LANs). More specifically, the present invention relates to the automatic configuration of wireless devices to form relatively local distance wireless networks, such as the wireless LAN.

2. Description of the Prior Art

In today's relatively local distance wireless networks, as exemplified by an IEEE 802.11 wireless LAN, a wireless LAN client station communicates with other wired or wireless LAN client stations and the Internet through a dedicated wireless LAN access point (AP). A wireless network is relatively local distance in the sense that cellular wireless networks are on the large distance side and other wireless networks, built around standards like IEEE 802.11, HiperLAN, HomeRF, or Bluetooth, are on the local distance side. The dedicated AP is typically a hardware device that acts as a communication hub so that users of wireless devices can connect to the network. Such a dedicated AP is fixed in space and, therefore, defines a finite coverage area in which the mobile client stations can roam while still maintaining active communications within the wireless LAN. Because the location of the dedicated AP is fixed, a wireless LAN designer must carefully plan its positioning to both define and maximize the necessary coverage area of the network.

Furthermore, multiple dedicated APs are often installed within one wireless LAN. In at least those commercially available prior art wireless networks that comply with the 802.11 standard, each dedicated AP typically serves to relay communications between client stations and the wired network, which limits their placement. This interconnected set of dedicated APs will define the finite coverage area of the wireless LAN. It will be apparent to those skilled in the art that gaps of lapses in coverage within the intended coverage area may exist if too few of these dedicated APs are used or if they are not properly space within the coverage area. However, having APs located too proximate to one another can lead to interference and other problems. Therefore, the added complexity of multiple dedicated APs compounds the problems of positioning each AP and additionally mandates tedious manual configuration and maintenance of each AP to achieve the desired coverage area.

Therefore, what is needed is a practical method and system for decreasing the complexity of wireless LAN configuration and maintenance, while still providing improved coverage and reach.

### SUMMARY OF THE INVENTION

A wireless distribution system and method in accordance with the present invention provides a flexible, automatically configured wireless network with extended reach and improved coverage through the use of a dual mode wireless network software access point (Soft AP), which can be configured dynamically to function either as a client station or as a software-based access point with client station functionality. The dual mode Soft AP device adds flexibility to the wireless network design by not requiring dedicated APs, but rather by allowing Soft APs to reside anywhere within the wireless LAN and to be automatically reconfigured as a client station or an access point using network intelligence which analyzes the needs of the network at that location and at that time. Thus the intelligence of the wireless distribution system of the present invention may include both a temporal and a physical component.

The Soft AP integrated into a wireless device allows a wireless network to be configured automatically with minimal user intervention. Such automatic configuration includes: whether to configure the Soft AP enabled device to be a Station Node or an AP Node; specifics of wireless radio link configuration, routing or bridging relationships with other networking devices attached to the host-computing device; and firewall configuration. Such automatic configurations are based on the automatic detection of the network environment attached to the Soft AP enabled device. The automatic configurations may also be based on the intelligent interactions among different Soft AP enabled devices in the wireless network, which often includes devices with and without Soft AP functionalities.

### BRIEF DESCRIPTION OF THE DRAWINGS

These and other aspects and features of the present invention will become apparent to those ordinarily skilled in the art upon review of the following description of specific embodiments of the invention in conjunction with the accompanying figures, wherein:

FIG. 1 shows a broadband gateway according to an embodiment of the present invention;

FIG. 2 illustrates a Soft AP device serving as an access point between wired and wireless devices according to an embodiment of the present invention;

FIG. 3 illustrates a wireless bridge between one Soft AP host and another Soft AP host according to an embodiment of the present invention;

FIG. 4 illustrates another wireless bridge between one Soft AP host and another Soft AP host according to an embodiment of the present invention;

FIG. 5 illustrates a network suitable for both a home or enterprise environment according to an embodiment of the present invention;

FIG. 6 illustrates the exemplary generic wireless network used to show features and aspects of the present invention;

FIG. 7 illustrates the overall process of automatic configuration of a wireless network containing the set S of wireless nodes according to an embodiment of the present invention; and

FIG. 8 illustrates the process of self-configuration of the initially isolated wireless nodes in S to establishing the wireless network according to an embodiment of the present invention.

### DETAILED DESCRIPTION OF THE INVENTION

The present invention will now be described in detail with reference to the drawings, which are provided as illustrative examples of the invention so as to enable those skilled in the art to practice the invention. Notably, the figures and examples below are not meant to limit the scope of the present invention. Moreover, where certain elements of the present invention can be partially or fully implemented using known components, only those portions of such known components that are necessary for an understanding of the present invention will be described, and detailed descriptions of other portions of such known components will be omitted so as not to obscure the invention. Further, the present invention encompasses present and future known equivalents to the known components referred to herein by way of illustration.

Overview

In the typical wireless LAN, a device is either manually configured to be a dedicated access point (AP) or manually configured to be a client station, and does not have the functionality of both. In the present invention, a wireless device includes a software AP (Soft AP). Such a wireless device is said to be Soft AP capable. The Soft AP capable device contains the functionality of both a client station and a wireless LAN AP, and can be configured to emulate one or the other, or both, at any given time.. The Soft AP can function with a variety operating systems (e.g., Windows, Linux, Unix, Lindows, MacOS, etc.) and on a variety of wireless devices (e.g., Desktops, Laptops, Personal Digital Assistants, etc.). Further, the Soft AP of the present invention can either be host-based or not; that is, the Soft AP will either use the host device processor or its own processor to perform its software functions.

In one embodiment of the present invention the Soft AP is designed to function in a Windows environment. In this exemplary embodiment, the Soft AP is a dual mode Network Interface Card (NIC) with a Network Driver Interface Specification (NDIS) NIC miniport driver and an NDIS intermediate driver. The NIC miniport driver supports both standard NDIS services as well as Object Identifier (OID) functions for the wireless LAN. The NDIS intermediate driver is designed to work with a wireless LAN device and is built with both station and access point capabilities in its Media Access Control (MAC) layers. The wireless device operating with the Soft AP will be registered with the device operating system as a network adapter.

Using devices configured with the Soft AP within a wireless LAN has dramatically increased the flexibility of a traditional wireless LAN using only dedicated APs. A Soft AP capable device, as in the present invention, can replace some or all of the dedicated APs. This replacement results in a more flexible and dynamic coverage area, as the Soft AP devices are typically mobile and can be either an AP or a client station as needed. Note that throughout this disclosure, whenever the Soft AP is referred to as being an AP, it is meant that the Soft AP is performing the functions of the traditional dedicated AP while at the same time allowing the device to be used as a client station. Whenever the Soft AP is acting as a client station, it is only performing those functions typically associated with a client station.

The reduced cost and increased flexibility of the Soft AP solution, as contrasted to dedicated APs, will inevitably result in their increased use within existing wireless LANs, until there are an overabundance of AP-capable wireless devices (i.e., the dedicated APs plus the additional Soft AP devices) to complete the wireless LAN within the given environment. This means that some of these AP-capable wireless devices might need to be configured as APs while others are not. Furthermore, as Soft APs are mobile devices, it is no longer feasible to select a static group of AP-capable devices to be dedicated APs for the Soft AP mobile environment.

Another aspect of the present invention arises when a wireless LAN contains a large number of AP-capable wireless devices and not all of these devices are required to be configured as an AP to achieve certain networking goals of the wireless LAN, such as maximizing the overall throughput of the entire network. In this situation, only a selected number of the Soft AP devices might need to be configured as APs to complete the wireless LAN, with the remaining Soft AP devices acting as mobile clients. Additionally, as the mobile Soft AP devices move within the wireless LAN or as new mobile Soft AP devices are added to the wireless LAN, the selection between AP or non-AP configuration necessarily changes over time.

Therefore, the present invention provides a wireless network Soft AP integrated into a wireless device allowing a wireless network to be configured automatically and dynamically maintained with minimal user intervention. The Soft AP includes the necessary drivers (e.g., AP, client, WDS, bridging, etc.) and the protocol routing, firewall and Dynamic Host Configuration Protocol (DHCP) server functions. The automatic configuration includes: whether to configure the Soft AP enabled device to be an AP Node or a Station Node; specifics of wireless radio link configuration, routing or bridging relationships with other networking devices attached to the host-computing device; and firewall configuration. Such automatic configurations are based on the automatic detection of the network environment attached to the Soft AP enabled device. The automatic configurations may also be based on the intelligent interactions among different Soft AP enabled devices in the wireless network, which often includes devices with and without Soft AP functionalities.

Having provided this overview of the basic structure of the present invention, the details of the invention will now be presented.

Broadband Gateway

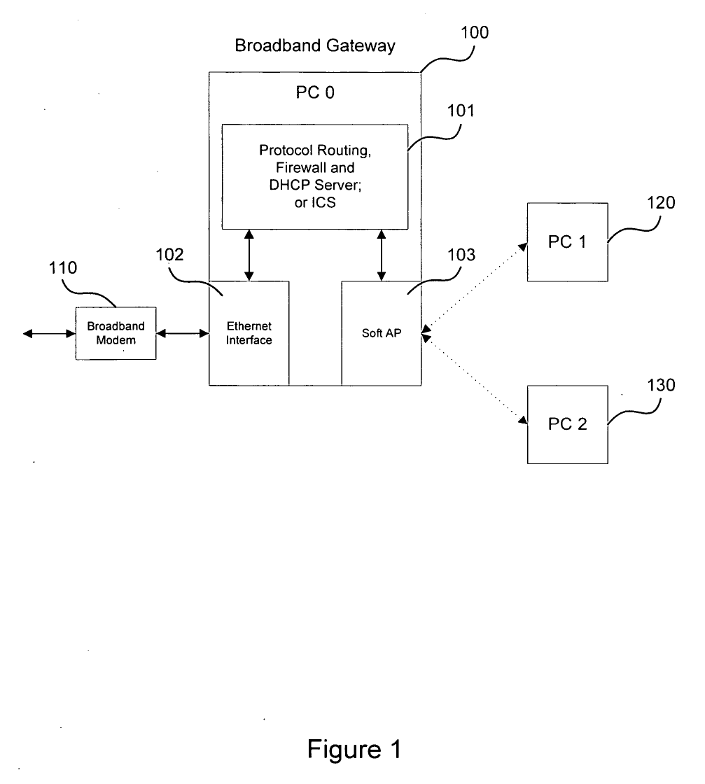

FIG. 1 shows a broadband gateway according to an embodiment of the present invention. As shown in FIG. 1 according to one aspect of this embodiment, the broadband gateway enables wireless devices PC 1 (120) and PC 2 (130) to connect to the Internet wirelessly through the Soft AP network interface (103) inside PC 0 (100) via the Ethernet interface (102) and the broadband modem (110). According to another aspect of this embodiment, broadband gateway can include protocol routing, firewall and DHCP server functions (101), such as those provided by the Microsoft Internet Connection Sharing (ICS) if PC 0 (100) runs a Microsoft Windows operating system. Note that the “PC” designation used in the drawings should in no way limit the scope of the present invention. As will be obvious to those skilled in the art in view of this disclosure, each “PC” designated device can be any wireless network device, such as a laptop, PDA or cell phone, that is capable of utilizing the Soft AP of the present invention.

As an example of this embodiment of the present invention, a Microsoft Internet Connection Sharing (ICS) enables the wireless device Internet connection. In this broadband Internet gateway, when ICS is enabled on the Ethernet interface (102) serving the Soft AP network interface (103), an IP address, like 192.168.0.1, is assigned to the Soft AP network interface (103). PC 1 (120) and PC 2 (130) can then obtain dynamic IP addresses, like 192.168.0.x, once their wireless LAN cards are associated with the Service Set Identifier (SSID) of the Soft AP (103). Further, the wireless LAN cards of PC 1 (120) and PC 2 (130) could also be Soft AP network interfaces functioning in client station mode. However, the ICS between the Soft AP network interface (103) and the wired Ethernet interface (102) must still be set up, either manually and independently of Soft AP or automatically and dynamically as part of Soft AP.

Ethernet to Soft AP Bridge

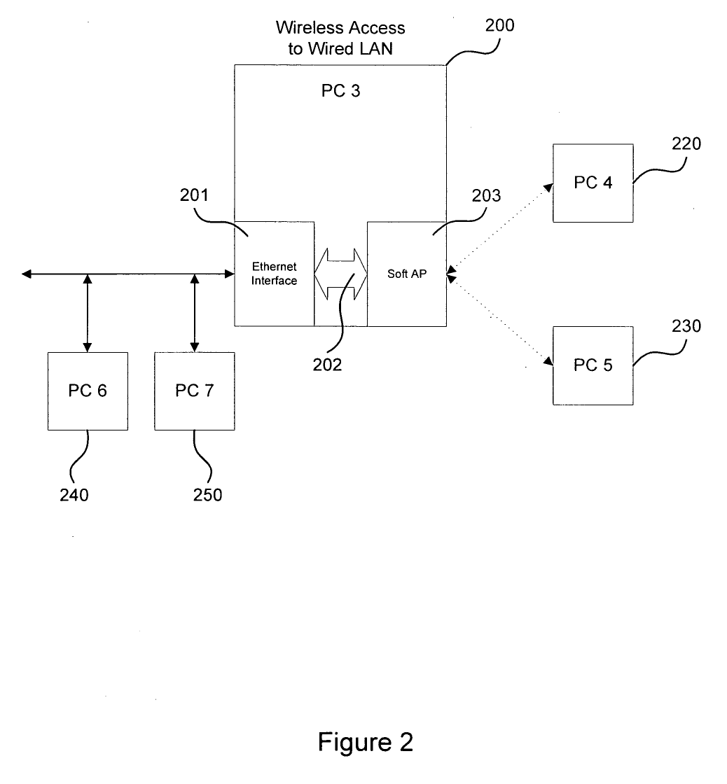

FIG. 2 illustrates a Soft AP device serving as an access point between wired and wireless devices according to an embodiment of the present invention. As sown in FIG. 2, the Soft AP host PC 3 (200) acts as a wireless access point for wireless PC stations (220, 230), bridging them to wired PC stations (240, 250). Such a MAC layer bridge (202) of the present invention merges the wireless LAN with the wired LAN by bridging the wired Ethernet interface (201) and the Soft AP network interface (203). This bridge forms a single logical LAN of all PC stations, including the Soft AP host PC 3 (200). Any PC station in this logical wireless LAN may act as a DHCP server (e.g. PC 4, 240). However, the bridging (202) between the Soft AP network interface (203) and the wired Ethernet interface (201) must still be set up, either manually and independently of Soft AP or automatically and dynamically as part of Soft AP.

Note that the bridge (202) between the wireless and the wired networks of PC stations are transparent to Layer 3 protocols such that a wireless PC station on one side of the Soft AP host PC 3 (200) can directly talk to a wired PC station on the other side of the Soft AP host PC 3 (200) without going through a layer 3 proxy or gateway.

An example of this embodiment of the present invention includes a Windows XP built-in MAC Bridge Miniport Driver that can be used to bridge the Ethernet network interface (201) and the Soft AP network interface (203).

Wireless Bridge

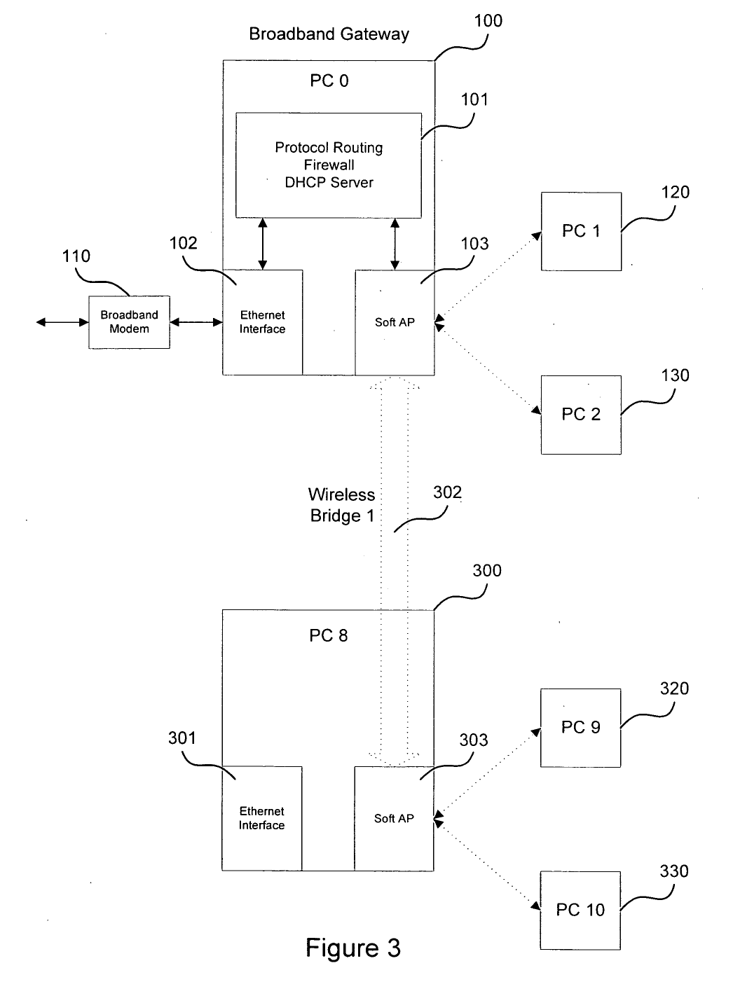

FIG. 3 illustrates a wireless bridge (302) bridging one Soft AP host PC 8 (300)-to another Soft AP host PC 0 (100) according to the present invention. As shown in FIG. 3, the Soft AP (303) in the far-end (i.e., relative to the broadband gateway, 100) host PC 0 (100) is used as a wireless bridging access point, serving wireless PC stations (320, 330), which are too far to associate with the near-end Soft AP (103) of the broadband gateway PC 0 (100). Such a wireless bridge (302) might, for example, be done in the MAC layer implementing a Wireless Distribution System (WDS). This wireless bridge (302) merges the wireless LAN associated with the Soft AP network interface (303) in PC 8 (300) with the wireless LAN associated with the Soft AP network interface (103) in PC 0 (100). This merges the two wireless LANs associated, respectively, with the two Soft AP's (103, 303) into a single logical LAN, and all wireless stations (120, 130, 320, 330) in this single logical LAN can access the Internet through the broadband gateway PC 0 (100). For instance, PC 10 (330) can talk to PC 1 (210) directly without going through a layer 3 proxy or gateway. This single logical wireless LAN expands that of FIG. 1, extending the wireless reach of the Soft AP (103) hosted in PC 0 (100).

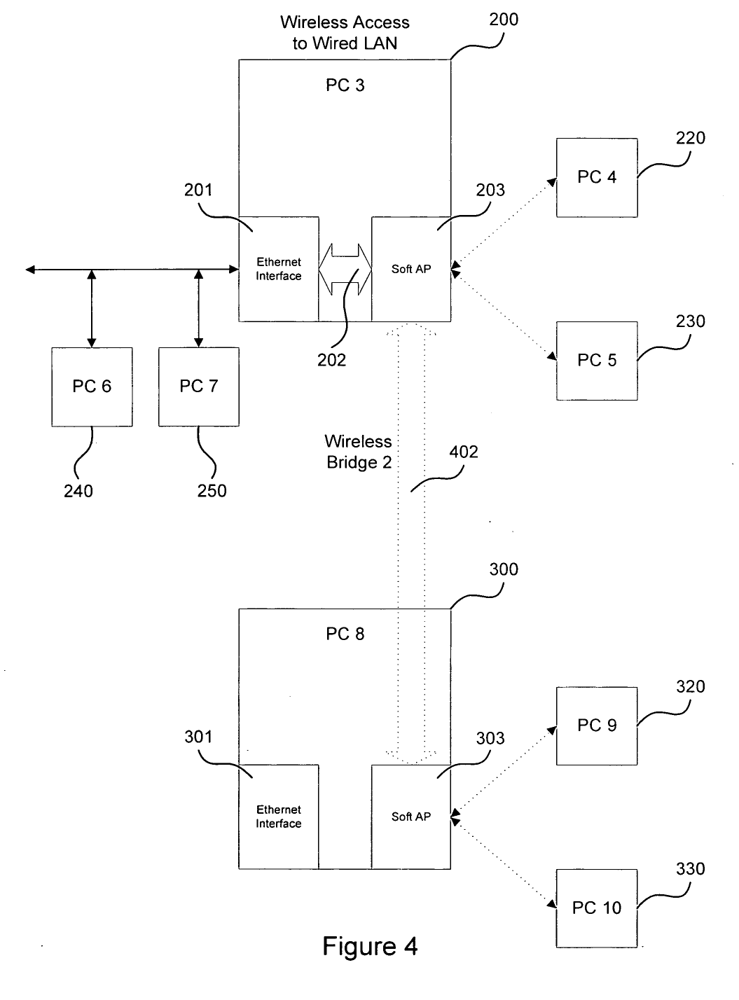

FIG. 4 illustrates another wireless bridge (402) bridging one Soft AP host PC 8 (300) to another Soft AP host PC 3 (200) according to the present invention. As shown in FIG. 4, the Soft AP (303) in the far-end (i.e., relative to the wired LAN access, 200) host PC 8 (300) is used as a wireless bridging access point, serving wireless PC stations (320, 330), which are too far to associate with the near-end Soft AP (203) of the wired LAN access PC 3 (200). Again, the two Soft AP's (203, 303) might, for example, form a WDS in the MAC layer, that bridges (402) between the wired and the wireless sides in PC 3 (200) to form a single logical LAN that includes all PC stations, wired or wireless, far or near, relative to the wired section of the logical LAN (240, 250). This single logical LAN expands that of FIG. 2, extending the wireless reach of the Soft AP (203) hosted in PC 3 (200).

The WDS in FIG. 3 (or that in FIG. 4) by itself forms a LAN with its two constituent Soft APs (103 and 303 in FIG. 3, 203 and 303 in FIG. 4) as the network nodes. Such a WDS LAN is bridged in layer 2 with the two wireless LANs associated with the two respective Soft APs (103 and 303 in FIG. 3, 203 and 303 in FIG. 4) forming a single logical wireless LAN that has farther reach than either of the two physical wireless LANs separately. Of course, the wireless throughput from a wireless PC station in one physical wireless LAN to a wireless PC station in the other physical wireless LAN will be cut in half as the link goes through two access points as opposed to through only one access point for a single physical wireless LAN. Note that in this discussion, the wireless LAN associated with a single access point is referred to as a physical wireless LAN, and the wireless LAN merged through a wirelessly bridged LAN is referred to as a logical wireless LAN.

A Home or Enterprise Network

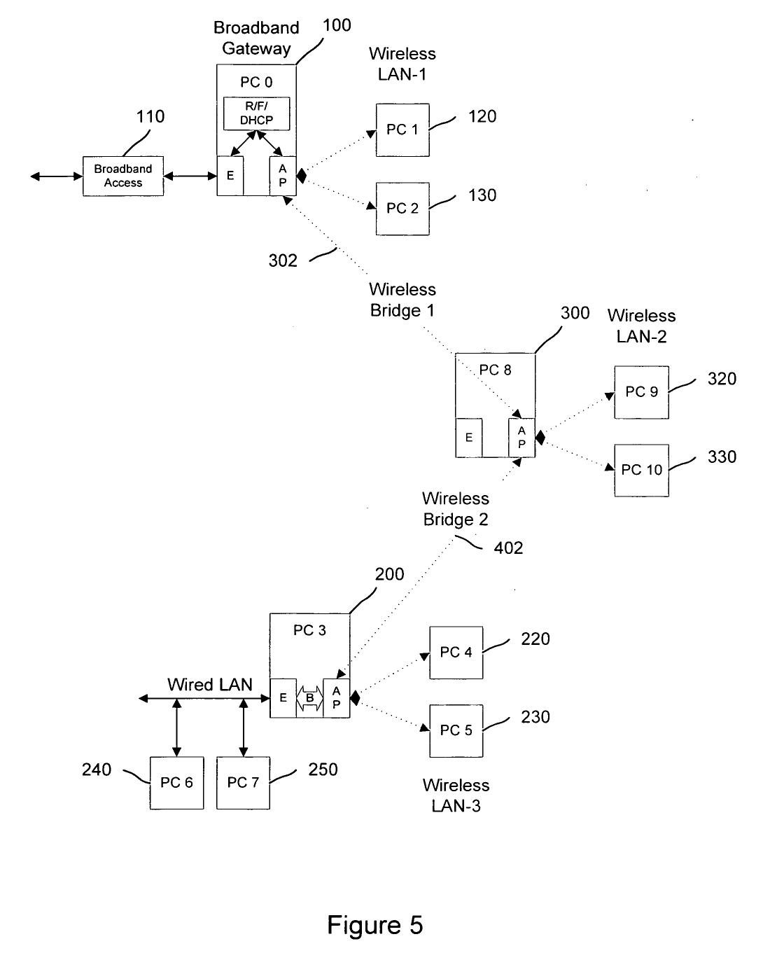

FIG. 5 illustrates a network suitable for both a home or enterprise environment according to the present invention. Such a network is a combination of the network segments depicted and discussed in FIG. 1 through FIG. 4, above. As shown in FIG. 5, PC 0 (100) is the broadband access gateway. PC 1 (120) through PC 10 (330) form a single logical LAN behind the gateway (100), merging wired PC stations (240, 250) with several groups of wireless stations (120, 130, 200, 220, 230, 300, 320, 330) via both Ethernet-to-AP and wireless bridges. Note that PC 1 (501) through PC 10 (510) could be any wireless network capable device, such as a laptop, PDA or cell phone, and are not meant to be limited by the “PC” nomenclature. FIG. 5 is discussed in further detail, below.

Network and Device Configuration

An embodiment of the present invention presents methods and systems for the automatic configuration of wireless local area networks (LANs). This disclosure uses an exemplary generic wireless network to illustrate the features and aspects of this embodiment of the present invention. Those skilled in the art will recognize that the disclosures herein can easily be applied to other network types, and such applications are meant to be within the scope of the present invention.

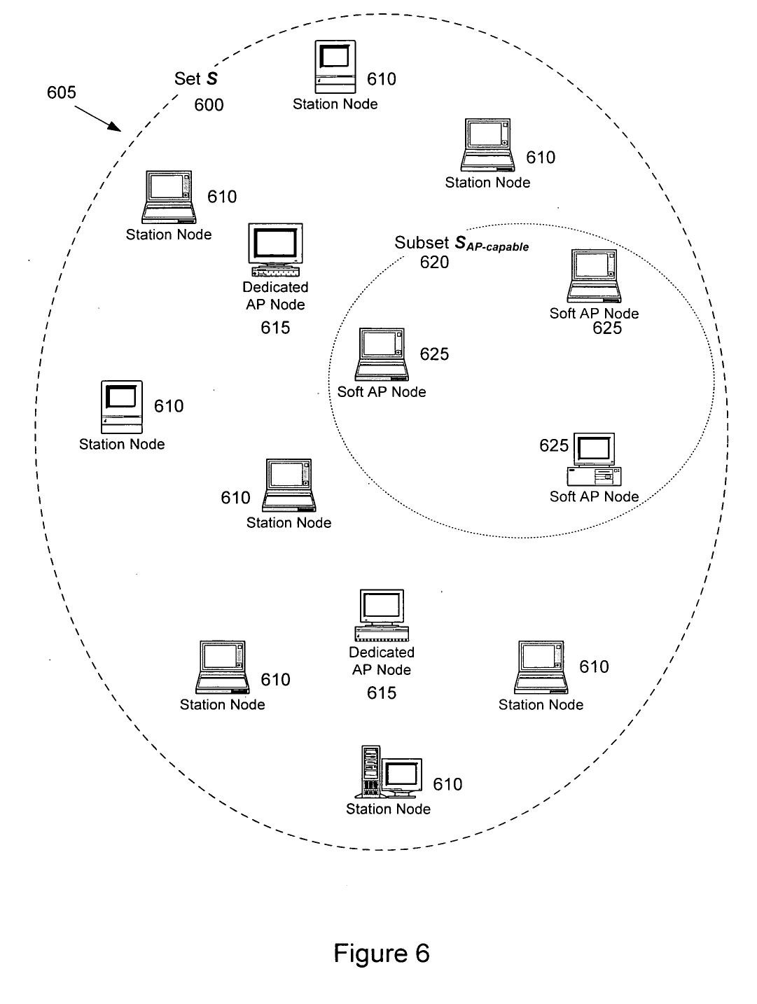

FIG. 6 illustrates the exemplary generic wireless network used to show features and aspects of the present invention. As shown in FIG. 6, the generic wireless network consists of a set S (indicated at 600) of wireless network devices, or nodes, indicated generally at 605, that communicate with neighboring nodes 605 wirelessly. The relative positions among the nodes 605 may change from time to time and the number of nodes 605 in the set S changes over time as well. Each wireless network device 605 behaves either as a Station Node, indicated at 610, or an Access Point (AP) Node, indicated at 615. A Station Node 610 communicates with other wireless nodes only through first communicating with an AP Node 615. That is, there is no Station Node to Station Node direct wireless communication in the exemplary generic wireless network.

Station Node communication is possible only after it is associated with an AP Node. Further, a Station Node 610 can be associated with only one AP Node 615 at any given time. An AP Node 615 communicates directly with neighboring AP nodes 615 and to Station Nodes 610 that are associated to it. In this way, the AP Node 615 serves as a relay station for other AP Nodes 615 and other Station Nodes 610 attempting to communicate wire lessly with a particular Station Node 610 that is associated to it. Therefore, within the exemplary generic wireless network, any node, or device, in the network can communicate with any other node through one or more AP Nodes 615.

Within the set S of wireless devices of the exemplary generic wireless network, there is a subset S_{AP-capable}, indicated at 620, of nodes that are capable of behaving either as an AP Node or as a Station Node, for example, the subset S_{AP-capable} nodes 620 might be Soft AP nodes, indicated at 625. In the context of wireless networks, and as previously discussed, a Soft AP node 625 is defined as a device that can be configured as either a wireless client station or a wireless AP. They can be configured dynamically, or automatically, to be an AP Node 615 or a Station Node 615 depending on the communication needs among all the wireless nodes in S.

Automatic, or dynamic, configuration of the wireless nodes in S means that each wireless network node can be automatically configured such that the wireless network can be formed. Such automatic configuration of each wireless devise can involve many aspects, including: configuring a node to be an AP Node or a Station Node if that node is AP-capable; for Station Nodes, configuring the node to associate with a neighboring AP Node to establish a direct wireless link between that Station Node and the wireless network; and for AP Nodes, configuring the node to establish a direct wireless link with a selected number of neighboring AP Nodes in the wireless network using, for example, the Wireless Distribution System (WDS).

In one embodiment, the present invention can be implemented as a piece of software that runs on each wireless node and can configure the host device accordingly, such that the wireless network S can be formed and maintained indefinitely. A wireless node automatically configures itself to behave a certain way by running the software implementation of the present invention on the device to configure it to behave as such. Therefore, automatic configuration can also be referred to as self-configuration. Likewise, when the wireless nodes in S configure themselves automatically, the wireless network S self-configures.

According to one aspect of an embodiment of the present invention, the wireless network of nodes in S may need to be authenticated and authorized to be part of S by some means. One such means according to an embodiment of the present invention uses the concept of network identification. In this embodiment, the set S of wireless nodes have the same network identification ID_{S}. Such a network identification ID_{S} is defined to include a set of network parameters that are necessary for a wireless network node to become part of S. For example, in the case of a wireless LAN, the network parameters might include the Service Set Identifier (SSID) and the Wired Equivalent Privacy (WEP) key. In other words, wireless network nodes already in S have means to know if a particular wireless node that comes into range of S is authorized to join the network S.

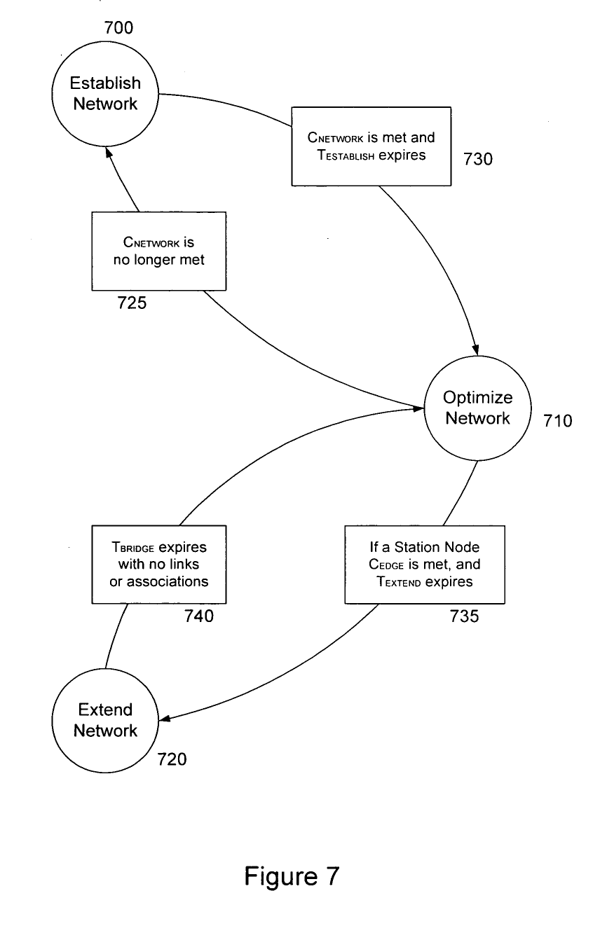

Thus, assuming the wireless network nodes in S can be properly authenticated and authorized to be part of S, a key aspect of this embodiment of the present invention is concerned with how a group of originally isolated wireless network nodes in S with the same ID_{S} can form the wireless network, and how this wireless network can be maintained by actions taken by the individual nodes in S, while optimizing the wireless network performance according to certain criteria C_{NETWORK}, illustrated in FIG. 7. The criteria C_{NETWORK} are a set of conditions against which a wireless node can test, such that if C_{NETWORK} is met for the node, the configuration of the node is considered to be satisfactory in the sense that such configuration will remain the same until C_{NETWORK} is no longer valid for the node. An example of such a criterion in C_{NETWORK} is to minimize the number of nodes that need to be configured as AP nodes, under the condition that all wireless nodes must have the same ID_{S} and be within the range of S. Another example is to maximize the overall throughput of the wireless network formed by the devices in S. A third example might be whether the node can reach the Internet; another might be whether the node can reach a particular server on the network included in S. Yet another example is, assuming a particular node is configured as an AP Node, whether there is any other node that has been associated to it as a Station Node within a specified time limit. When such a time limit expires without a Station Node associating to it, the AP Node can configure itself as a Station Node and scan for an available AP Node in range.

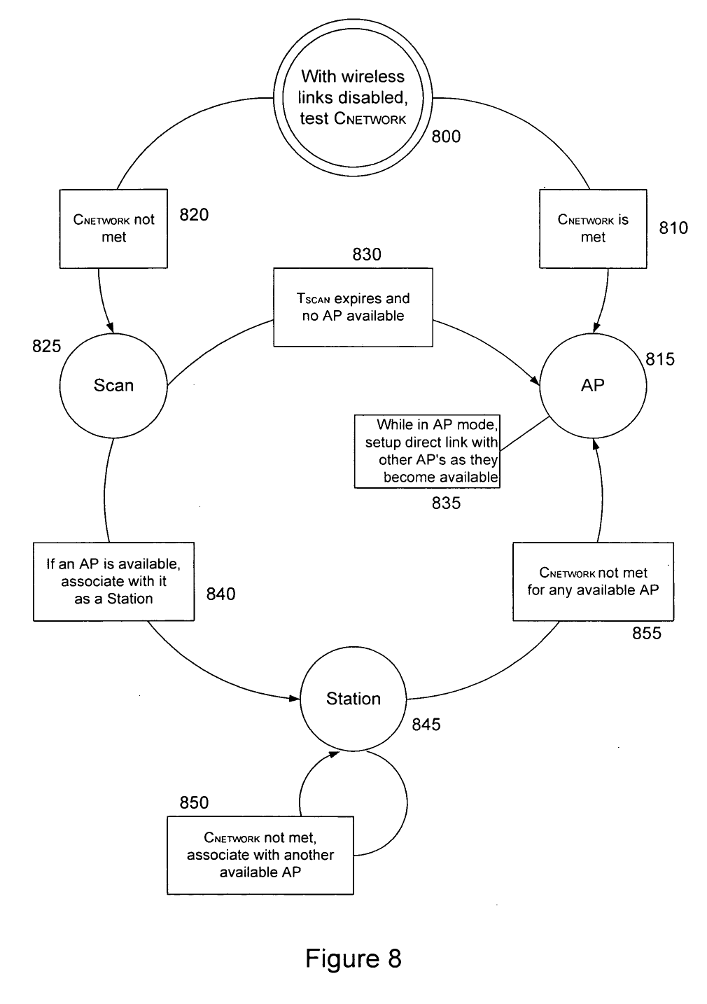

FIGS. 7 and 8 illustrate the overall process of automatic configuration of a wireless network containing the set S of wireless nodes 605 and can be decomposed into three phases that reflect three different goals. The first phase, indicated at 700, is to initiate or establish the wireless network. The second phase, at 710 is to optimize the wireless network after it has been established. The third phase, indicated at 720, is to extend the wireless network. Automatic configuration of the wireless network is an on-going process, which may dynamically shift from one phase to another with minimal disruption to the existing network connections of S. Each of these three phases is discussed in further detail below.

Establishing the Wireless Network

FIG. 8 illustrates the process of self-configuration of the initially isolated wireless nodes in S to establishing the wireless network. For this aspect of the present invention, assume that the set S of wireless nodes all have the same network identification ID_{S} and initially are each isolated from all others nodes, as indicated at 800. The process of connecting initially isolated nodes into a wireless network corresponds to the phase of establishing the wireless network, shown generally at 700 in FIG. 7. The purpose of establishing the wireless network is for the nodes in S to self-configure such that C_{NETWORK} can be met for each node by forming a wireless network. All nodes in S will simultaneously perform the initial network establishment procedure. The process of establishing the wireless network also applies to the still isolated nodes when the other nodes in S are already connected with one another wirelessly (i.e., when part of the wireless network has been established and there is still an isolated node that needs to join the network).

Without initially being connected to any other node wirelessly, a wireless node in S will first check to see whether C_{NETWORK} is met, as indicated at 810. If C_{NETWORK} is met, that node configures itself as an AP Node until C_{NETWORK} is no longer met, as indicated at 815. Such an AP Node is labeled as a master AP node. If C_{NETWORK} is not met, as indicated at 820, that node scans for an AP Node, as indicated at 825, for a maximum time period of T_{SCAN} as indicated at 830. If no AP Node is found, that node also configures itself as an AP Node, as shown at 815. One characteristic of C_{NETWORK} according to the present invention is that C_{NETWORK} can be different depending on whether a node is configured as an AP Node or a Station Node.

Each of those nodes that have configured themselves as AP Nodes without meeting their corresponding criteria C_{NETWORK} will stay in the initially established configuration for a time period of T_{ESTABLISH}, as indicated at 730 in FIG. 7, during which, it periodically checks for other newly established AP Nodes in range. Whenever there is another AP Node in range, it will setup a direct wireless link (e.g., a WDS link) with that in-range AP Node with itself staying configured as an AP Node, as shown at 835 in FIG. 8.

If there are one or more AP Nodes in range during scanning, as indicated at 840, that node will configure itself as a Station Node as indicated at 845 and associates with these in-range AP Nodes one at a time and checks if C_{NETWORK} is met as indicated at 850. If C_{NETWORK} is met when associated with a particular AP Node, it will stay associated with that AP Node, as shown at 840. If C_{NETWORK} is not met by associating with any of the AP Nodes, as shown at 855, then that node configures itself as an AP Node and sets up a direct wireless link (e.g., a WDS link) with all other AP Nodes in range.

As previously mentioned, every time a node configures itself as an AP Node, it will stay in the AP mode for a period of T_{ESTABLISH}. After this period expires, if C_{NETWORK} is still not met, it will restart the T_{ESTABLISH} timer and stay in the AP mode for another period, as shown generally at 725. The number of T_{ESTABLISH} cycles an AP Node goes through without ever meeting C_{NETWORK} is recorded and can be used as a condition for changing to a different C_{NETWORK}, which change may be aided by input from the user of the wireless device after first providing such condition information to the user. When C_{NETWORK} is met by the end of a T_{ESTABLISH} period, the node goes into the network optimization phase, as shown in FIG. 7 at 730.

Optimizing the Network

According to an embodiment of the present invention, the process of optimizing the network attempts to minimize the number of AP Nodes in S, while maintaining the connectivity among all of the nodes in S and the integrity of the wireless network.

As shown in FIG. 7, during optimization, an AP Node disconnects its direct wireless link (e.g., a WDS link) with another AP Node if such a disconnection does not invalidate C_{NETWORK}. If an AP Node only has one direct wireless link with only one other AP Node, it will signal all of the Station Nodes associated with it to try to re-associate with another AP Node. If all of the associated Station Nodes can and do re-associate with another AP Node, without invalidating their own C_{NETWORK}, the original AP Node will have no Station Nodes associated with it, yet still have the one direct wireless link to another AP Node. When an AP Node has no associated Station Nodes and no more than one direct wireless link to another AP Node, it will reconfigure itself as a Station Node and associate with the AP Node to which it had its sole direct wireless link.

Extending the Network

In a further embodiment of the present invention, a node configured as a Station Node that is located on the edge, or coverage periphery, of the wireless network periodically reconfigures itself as an AP Node for a period of T_{BRIDGE}, while setting up and maintaining a direct wireless link (e.g. a WDS link) with the AP Node it had been associated with before switching from a Station Node to an AP Node. This periodic reconfiguration is controlled by another time period TEXTEND, as shown in FIG. 7 at 735. While in the T_{BRIDGE} period acting as an AP Node, it waits for other Station Nodes to associate with it, or other AP nodes to link to it. If after this T_{BRIDGE} period no such associations and no direct wireless links are created, it reconfigures itself back to being a Station Node, as shown at 740.

A Station Node is said to be an edge Station Node if the criteria C_{EDGE} are met. The criteria C_{EDGE} are defined as a set of conditions for a Station Node to test against that reflects how far a Station Node is from a master AP node. One such condition is a distance measure reflected by the number of hops, or relays among AP Nodes, there are between the Station Node and the master AP Nodes. Another condition is the signal strength between the Station Node and the immediate AP Node to which it is associated. If the signal strength is too weak (e.g., below a certain predefined threshold), then the Station Node may be considered as an edge Station Node. A third example of such a condition is the combination of the number of hops a Station Node must go through to reach a master AP Node and the signal strengths between the relaying AP Nodes.

Node Configuration

Another embodiment of the automatic configuration of the present invention is the detailed node configuration required after a node in S switches from being a Station Node to an AP Node and vice versa. Such detailed node configuration can, for example, include the specifics of wireless radio link configuration, routing or bridging relationships with other networking devices, wired and wireless, attached to the device, and firewall configuration.

As previously discussed, FIG. 5 illustrates a typical wireless home or enterprise network enabled, at least in part, by Soft AP devices and other related technologies according to the present invention. As shown in FIG. 5, PC 0 (100) is the broadband gateway with broadband access (120). PC 1 (120) through PC 10 (330) form a single logical LAN behind the gateway (100), merging wired devices (240, 250) with several groups of wireless devices (120, 130, 200, 220, 230, 300, 320, 330) via both Ethernet-to-AP and wireless bridges. Again, note that PC 1 (120) through PC 10 (330) could be any wireless network capable device, such as a laptop, PDA or cell phone, and are not meant to be limited by the “PC” nomenclature.

With reference to FIG. 5, assume that in the network shown a subset of the PC stations (e.g. 100, 130, 200, 220, 300) are Soft AP capable wireless devices and the rest of the wireless devices have only a traditional wireless LAN client card installed. Manual configuration and setup for the wireless links for both the Soft AP capable devices and the wireless client devices can be a challenging task, especially when not every wireless device can reach all other wireless devices. In this situation some kind of radio planning must be involved.

In the traditional wireless network, manual radio planning is necessary to place and install the dedicated access points and wireless repeaters at strategic locations. However, in the Soft AP enabled wireless network (i.e., when Soft AP capable devices make up at least a subset of the total wireless devices in the wireless network), such radio link setups can be automated without user intervention. This is possible because Soft AP is natively interfaced to its host device and therefore is under full control of the host device. This control makes it possible to easily install the necessary software in the host device to dynamically configure selected Soft AP capable devices into either the AP mode or the wireless client mode. The dynamic configuration is based, at least in part, on the quality of the radio links among all wireless devices and on the dynamic bridging and/or routing needs of the wireless network.

In addition to automatic radio planning link setups of the wireless portion of the network, a Soft AP enabled wireless network allows automatic IP network configuration and diagnostic, and application profile management, further simplifying that task of setting up wireless or mixed wired and wireless networks. It is worth noting, however, that the foundation for such higher-level automations is the ability of automatic configuration of wireless radio links enabled by the Soft AP technology.

Although the present invention has been particularly described with reference to the preferred embodiments thereof, it should be readily apparent to those of ordinary skill in the art that changes and modifications in the form and details thereof may be made without departing from the spirit and scope of the invention. For example, those skilled in the art will understand that variations can be made in the number and arrangement of components illustrated in the above block diagrams. It is intended that the appended claims include such changes and modifications.

1. A method for dynamically configuring a wireless network comprising the steps of
testing a first wireless node against a predetermined criteria,
establishing the first node as an access point if the predetermined criteria is satisfied and establishing a link with a second node, and
establishing the first node as a station node if the predetermined criteria is not met and an association can be made with an access point.

2. The method of claim 1, further including the step of
establishing the first node as an access point if the predetermined criteria is not met and no association can be made with an access point after a predetermined period of time.

3. The method of claim 1, further including the step of periodically retesting at least some nodes of the network to permit reconfiguration of the nodes as either access points or station nodes in accordance with the predetermined criteria.

4. A method of dynamically configuring a wireless network including the steps of
establishing the network among a plurality of nodes by establishing at least one of the nodes as an access point and at least one other node as a station node,
optimizing the network by minimizing the number of access points while maintaining a wireless connection to each node within the network, and
extending the network by connecting to newly added nodes, including reconfiguring an existing station node as an access point if required to establish communication with the newly added node.

5. The method of claim 4 further including the step of comparing a node against a predetermined criteria to determine if the node is an edge node.

6. The method of claim 4 further including the step of testing a node against a predetermined criteria to determine whether to configure that node as an access point or a station node.

7. The method of claim 6 further including the step of periodically verifying whether the predetermined criteria is still met.

8. The method of claim 7 further including the step of reconfiguring the node in accordance with whether the predetermined criteria is still met.

9. The method of claim 6 further including associating a node with an access point within the network.

10. The method of claim 9 further including testing the association of a node with a plurality of access points to determine whether to associate with at least one of the access points.

11. The method of claim 10 further including the step of configuring a node as an access point if the results of the testing result in no association being made with a pre-existing access point.

12. A dynamically reconfigurable network comprising
a plurality of nodes, at least some of the nodes being capable of being configured as either an access point or a station node,
a computer program resident within at least some of the nodes for testing whether to establish a given node as an access point or a station node, and
a timer for causing at least one node to rerun the computer program.

13. The network of claim 12 wherein at least some of the nodes are not reconfigurable.

14. The network of claim 12 wherein the computer program includes a predetermined criteria against which performance of a node within its environment is tested to determine whether to configure that node as an access point or a station node.
